(19) United States
(12) Patent Application Publication
(10) Pub. No.: US 2021/0136879 A1
(43) Pub. Date: May 6, 2021

(54) HEATING MAT

(71) Applicant: DAOKOREA CO.,LTD., Jeonju-si, Jeollabuk-do (KR)

(72) Inventor: Youngchun JEON, Jeonju-si (KR)

(73) Assignee: DAOKOREA CO.,LTD., Jeonju-si, Jeollabuk-do (KR)

(21) Appl. No.: 16/628,619

(22) PCT Filed: Nov. 24, 2017
(86) PCT No.: PCT/KR2017/013474

§ 371 Date: Jan. 3, 2020

(30) Foreign Application Priority Data
Jul. 5, 2017 (KR) 10-2017-0085363

(51) Int. Cl. H05B 3/26; H05B 3/14

(52) U.S. Cl. CPC H05B 3/262; H05B 3/145

(57) ABSTRACT

The present invention relates to a heating mat, and can provide a heating mat comprising: a surface layer formed from one of PVC, PU and TPU; a carbon heating element formed under the surface layer, emitting far infrared rays and generating heat; a short-circuit prevention layer provided under the carbon heating element; a copper plate provided under the short-circuit prevention layer and uniformly dispersing heat; a first cushion layer provided under the copper plate, and providing a cushiony feeling; and a bottom layer provided under the first cushion layer and coming into contact with the ground.

### TECHNICAL FIELD

The present invention relates to a heating mat, and more particularly to a heating mat that includes a surface layer, a carbon heater, a short-circuit prevention layer, a copper plate, a first cushion layer, and a bottom layer, is configured to evenly distribute heat to the copper plate, serves to block water veins, and is manufactured in an integrated form.

### BACKGROUND ART

In general, planar heaters can be classified into a metallic heater formed of nichrome, a copper nickel alloy, aluminum, or the like and a non-metallic heater made of a carbon material. A heater using carbon as a heating source is manufactured by coating a surface of a fiber or film with carbon by precipitation or a printing method.

A heater manufactured using carbon as a heating source is advantageous in that it does not generate electromagnetic waves, minimizes power consumption due to a constant temperature characteristic wherein a temperature does not increase any more upon reaching a certain temperature, and has no risk of burns.

In addition, the heater manufactured using carbon as a heating source does not cause air pollution and noise and emits far infrared rays which are hygienic and beneficial to the human body. Accordingly, such a planar heater is widely used as a material for heating sheets, heating mats, heating wall items, heating sheets, heating wires, climbing or functional clothing, bedding, agricultural seedling growth promoters, and vinyl house heating.

However, since conventional mats are manufactured by mounting heating wires in the form of a mat and sewing the same or covering a pocket cover thereon, growth of bacteria and deformation easily occur.

In addition, since water pulse waves, which are harmful waves radiated at points where water veins pass, have negative effects on the human body, livestock, and plants, particularly cause growth-induced diseases, there is a need for a solution to block water pulse waves.

In recent years, research on water pulse waves is being actively conducted in developed countries such as the UK, Europe, and Japan. In Korea, there is a need for development of a mat-type copper plate as a means for blocking water pulse waves, particularly development of a mat-type copper plate for covering the floor so as to reduce the influence of harmful waves during sleep.

In the case of commercially available copper plate mats, a copper plate itself is manufactured in a mat shape, or thinly-cut copper plates are woven into a mat shape to manufacture a copper plate mat. However, since such copper plate mats are thin and are not manufactured densely, water vein blocking effect thereof is insufficient.

### DISCLOSURE

### Technical Problem

Therefore, the present invention has been made in view of the above problems, and it is one object of the present invention to provide a heating mat that includes a surface layer, a carbon heater, a short-circuit prevention layer, a copper plate, a first cushion layer, and a bottom layer, is configured to evenly distribute heat to the copper plate, serves to block water veins, and is manufactured in an integrated form.

### Technical Solution

In accordance with an aspect of the present invention, the above and other objects can be accomplished by the provision of a heating mat according to a first embodiment of the present invention, the heating mat including: a surface layer formed of one of PVC, PU and TPU; a carbon heater provided under the surface layer and configured to emit far infrared rays and generate heat; a short-circuit prevention layer provided under the carbon heater; a copper plate provided under the short-circuit prevention layer and configured to uniformly disperse heat; a first cushion layer provided under the copper plate and configured to provide a feeling of cushion; and a bottom layer provided under the first cushion layer and configured to be in contact with the ground.

In addition, the short-circuit prevention layer may be a yarn formed of natural fiber and the natural fiber may be one or more of pineapple leaf fiber, cotton fiber, coconut fiber, bamboo fiber, banana fiber, ramie fiber and manila hemp.

In addition, the short-circuit prevention layer may be formed of a highly elastic foam.

In addition, the surface layer may be formed to surround from an upper surface of the heating mat to a portion of a lower surface of the heating mat, and the bottom layer may be finished using an adhesive to be connected to the surface layer on the lower surface of the heating mat, and then finished using silicone.

In addition, a coating layer may be further provided on the surface layer, wherein the coating layer includes one or more liquids and nanoparticle powders derived from silver compounds, germanium, bentonite, bamboo charcoal, jade, charcoal, feldspar rock, diatomite, and cypress.

In addition, the coating layer may further include a herb, wherein the herb includes at least one of dill, anise, laurel, oregano, tarragon, basil, sage, thyme, peppermint, chervil, cilantro, rosemary, hyssop, borage, lovage, savory, and lemon balm.

In addition, the coating layer may further include a UV coating agent, wherein the UV coating agent is prepared by mixing 15 to 20 parts by weight of polyvinyl butyral (PVB), 90 to 95 parts by weight of an acrylic monomer, 0.5 to 1 part by weight of a photoinitiator, and 0.5 to 1 part by weight of one or more additives selected from an antifoaming agent, a pigment, a dispersant, and a UV stabilizer.

In addition, the copper plate may be formed by connecting a plurality of copper plate materials with an ‘S’-shaped cross section.

In addition, a durable pad may be further provided between the surface layer and the carbon heater.

In addition, a second cushion layer may be further provided between the surface layer and the carbon heater.

In accordance with another aspect of the present invention, there is provided a heating mat according to a second embodiment of the present invention, the heating mat including a surface layer formed of one of PVC, PU and TPU; a carbon heater provided under the surface layer and configured to emit far infrared rays and generate heat; a first cushion layer provided under the carbon heater and configured to provide a feeling of cushion; and a bottom layer provided under the first cushion layer and configured to be in contact with the ground.

In accordance with yet another aspect of the present invention, there is provided a heating mat according to a third embodiment of the present invention, the heating mat including a surface layer formed of one of PVC, PU and TPU; a durable pad provided under the surface layer; a first cushion layer provided under the durable pad and configured to provide a feeling of cushion; and a bottom layer provided under the first cushion layer and configured to be in contact with the ground.

### Advantageous Effects

As apparent from the above description, a heating mat according to an embodiment of the present invention includes a surface layer, a carbon heater, a short-circuit prevention layer, a copper plate, a first cushion layer, and a bottom layer and is configured to evenly distribute heat to a copper plate and block water veins.

In addition, the surface layer is formed of ecofriendly PVC, PU, or TPU, so that it is easy to clean foreign substances and the growth of bacteria can be prevented. Accordingly, the heating mat can benefit the environment and the human body.

In addition, since the heating mat is manufactured in an integrated form, it is durable and does not exhibit deformation even after long use.

In addition, since the heating mat can be used as a mat for exercise when not used as a heating mat, it can be used throughout the year.

### DESCRIPTION OF DRAWINGS

FIG. 1 is a perspective view illustrating a cut part of each layer of a heating mat according to a first embodiment of the present invention.

FIG. 2 is a front sectional view illustrating each layer of the heating mat according to the first embodiment of the present invention.

FIG. 3 is a schematic enlarged view illustrating a copper plate of the heating mat according to the first embodiment of the present invention.

FIG. 4 is a front sectional view illustrating each of layers, which include a durable pad and a second cushion layer, of the heating mat according to the first embodiment of the present invention.

FIG. 5 is a front sectional view illustrating each layer of a heating mat according to a second embodiment of the present invention.

FIG. 6 is a front sectional view illustrating each layer of a heating mat according to a third embodiment of the present invention.

### BEST MODE FOR CARRYING OUT THE INVENTION

To address the problems, the present invention provides a heating mat including a surface layer formed of one of PVC, PU and TPU; a carbon heater provided under the surface layer and configured to emit far infrared rays and generate heat; a short-circuit prevention layer provided under the carbon heater; a copper plate provided under the short-circuit prevention layer and configured to uniformly disperse heat; a first cushion layer provided under the copper plate and configured to provide a feeling of cushion; and a bottom layer provided under the first cushion layer and configured to be in contact with the ground.

In addition, provided is a heating mat according to a second embodiment of the present invention, the heating mat including a surface layer formed of one of PVC, PU and TPU; a carbon heater provided under the surface layer and configured to emit far infrared rays and generate heat; a first cushion layer provided under the carbon heater and configured to provide a feeling of cushion; and a bottom layer provided under the first cushion layer and configured to be in contact with the ground.

Further, provided is a heating mat according to a third embodiment of the present invention, the heating mat including a surface layer formed of one of PVC, PU and TPU; a durable pad provided under the surface layer; a first cushion layer provided under the durable pad and configured to provide a feeling of cushion; and a bottom layer provided under the first cushion layer and configured to be in contact with the ground.

### Mode for Carrying Out the Invention

As the invention allows for various changes and numerous embodiments, particular embodiments will be illustrated in the drawings and described in detail in the written description. However, this is not intended to limit the present invention to particular modes of practice, and it is to be appreciated that all changes, equivalents, and substitutes that do not depart from the spirit and technical scope of the present invention are encompassed in the present invention.

The terms such as “first” and “second” are used herein merely to describe a variety of constituent elements, but the constituent elements are not limited by the terms. The terms are used only for the purpose of distinguishing one constituent element from another constituent element.

Like reference numerals used throughout the specification denote like elements.

The expression of singularity in the present specification includes the expression of plurality unless clearly specified otherwise in context. Also, the terms such as “include” or “comprise” may be construed to denote a certain characteristic, number, step, operation, constituent element, or a combination thereof, but may not be construed to exclude the existence of or a possibility of addition of one or more other characteristics, numbers, steps, operations, constituent elements, or combinations thereof.

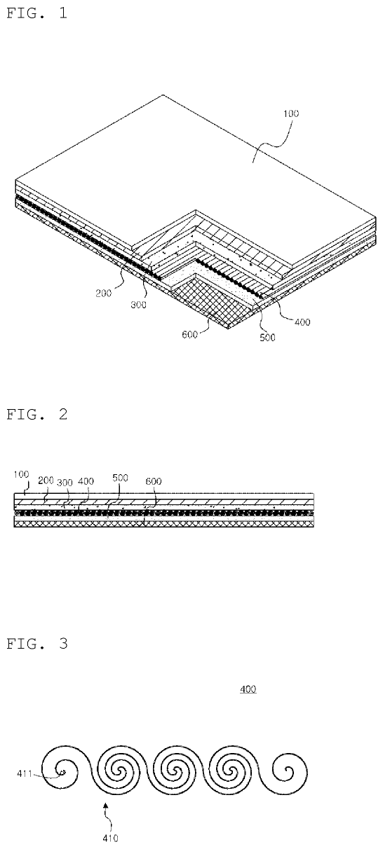

Hereinafter, the present invention will be described in detail by explaining exemplary embodiments of the invention with reference to FIGS. 1 to 6.

FIG. 1 is a perspective view illustrating a cut part of each layer of a heating mat according to a first embodiment of the present invention.

FIG. 2 is a front sectional view illustrating each layer of the heating mat according to the first embodiment of the present invention.

FIG. 3 is a schematic enlarged view illustrating a copper plate of the heating mat according to the first embodiment of the present invention.

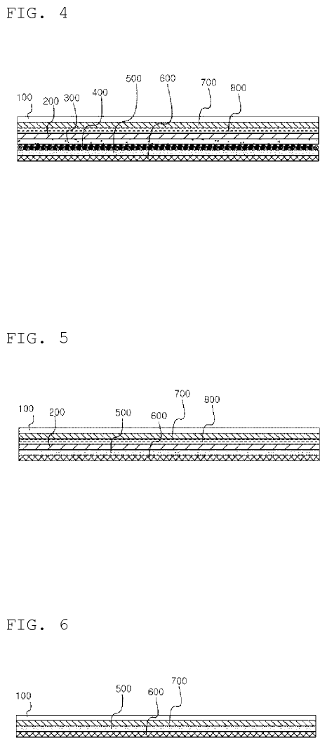

FIG. 4 is a front sectional view illustrating each of layers, which include a durable pad and a second cushion layer, of the heating mat according to the first embodiment of the present invention.

Referring to FIGS. 1 to 4, the heating mat according to the first embodiment of the present invention may include a surface layer 100, a carbon heater 200, a short-circuit prevention layer 300, a copper plate 400, a first cushion layer 500, and a bottom layer 600.

In particular, the surface layer 100 may be formed of PVC.

The surface layer 100 is made of polyvinyl chloride (PVC) and constitutes a surface of the heating mat. Particularly, the surface layer 100 may provide heat provided from the carbon heater 200 of the heating mat to a user and may increase a provision time of the heat.

In addition, the surface layer may be formed of polyurethane (PU) or thermoplastic polyurethane (TPU).

Polyurethane (PU) has satisfactory ozone resistance and abrasion resistance. In addition, since PU has excellent elasticity, it can reduce impact applied to the user's body.

Thermoplastic polyurethane (TPU) is durable and does not wear well. In addition, TPU prevents warping and has excellent elasticity and strength. In addition, TPU absorbs impact so that the impact is not applied to the user's body.

In addition, the surface layer 100 may include PVC, PU, or TPU and one or more of graphite, magnesium carbon oxide, a conductive polymer, magnesium, barium, silver and zinc.

The conductive polymer may be formed using one or more of polypyrrole, polyaniline, polyphenylene, polythiophene and polyacetylene.

The surface layer 100 includes one or more of graphite, magnesium carbon oxide, a conductive polymer, magnesium, barium, and silver and zinc, thereby providing improved thermal conductivity and, accordingly, increasing thermal efficiency of the heating mat.

In addition, the surface layer 100 may be formed on the top, may be formed to surround an upper surface of the heating mat and outer circumference surfaces of other layers such as the carbon heater 200, the short-circuit prevention layer 300, the copper plate 400, and the first cushion layer 500, and portions of a bottom surface of the heating mat, and may be finished to be connected to the bottom layer 600.

Accordingly, the surface layer 100 may be formed to cover the carbon heater 200, the short-circuit prevention layer 300, the copper plate 400, and the first cushion layer 500 of the heating mat, thereby fixing and protecting the carbon heater 200, the short-circuit prevention layer 300, the copper plate 400, and the first cushion layer 500.

In addition, each corner of the surface layer 100 may be sealed by melting PVC, PU, or TPU constituting the surface layer 100 by means of a hot rod.

The sealing prevents humidity or water from penetrating into the integrated heating mat, thereby maximizing the lifespan and elasticity of the heating mat.

In addition, the sealing may prevent the growth of bacteria due to moisture or water inside the heating mat.

In addition, the surface layer 100 may further include a coating layer formed thereon, thereby performing a spontaneous sterilization function to prevent the growth of bacteria due to moisture or water on an outer surface of the surface layer 100.

The coating layer may include one or more liquids and nanoparticle powders derived from silver compounds, germanium, bentonite, bamboo charcoal, jade, aluminum, graphite, charcoal, feldspar rock, diatomite, and cypress. However, these materials are merely examples for describing the present invention, and the present invention is not limited thereto and may further include materials having a sterilization function.

The silver compound may include a water- or organic solvent-soluble silver compound, such as silver nitrate. Particular examples of the solvent-soluble silver compound include a complex of silver ions and a complexing agent or a chelating agent. Such a silver complex compound is formed by adding a silver compound and a complexing agent to a solvent. The generated silver complex is used as a solution for the coating composition.

The complexing agent used with silver (I) ions to form a silver complex compound may include halogen ions, iodine, bromide, chloride(or corresponding hydrohalic acid), thio compounds, thiocyanogen compounds, sugars (e.g., pentose and hexose, e.g., glucose), β-dicarbonyl compound such as diketone (e.g., acetylacetonate), keto esters (e.g., acetoacetate and allylacetoacetate), ether alcohol, carboxylic acid, carboxylate (e.g., acetate, citrate or glycolate), betaine, diols, polyols (including polymeric polyols such as polyalkylene glycol), crown ethers, phosphorus compounds, mercapto compounds (e.g., 3-mercaptopropyltrimethoxysilane and 3-mercaptopropyltriethoxysilane) and amino compounds.

Particularly, mercapto compounds (e.g., mercaptosilanes and the like), amino compounds (e.g., aminosilanes, monoamines, diamines, triamines and tetraamines, other polyamines and the like) are preferred.

In particular, the organic amines may include triethylenetetramine, diethylenetetramine, diethylenetriamine, and ethylenediamine. The aminosilanes may include 3-aminopropyltriethoxysilane, 3-aminopropyltrimethoxysilane and 2-aminoethyl-3-aminopropyltrimethoxysilane (DIAMO), 2-aminoethyl-3-aminopropyltriethoxysilane, aminohexyl-3-aminopropyltrimethoxysilane and aminohexyl-3-aminopropyltriethoxysilane.

Since germanium is similar to silicon, it is widely substituted by silicon of silicate in the earth's crust and is contained in sulfide minerals and coals containing copper or zinc, but few minerals mainly containing germanium are present. Germanium has the effect of killing bacteria.

Bentonite can detoxify harmful factors such as viruses and fungi.

Bamboo charcoal has an adsorption effect, thereby being capable of removing odors generated during decomposition. Bamboo charcoal has bactericidal power, thereby being capable of inhibiting bacterial growth during decomposition.

Jade has the effect of decomposing harmful waste.

Charcoal is an amorphous carbon produced by heating an organic material such as wood in a state in which air is blocked. Activated carbon is charcoal heated to remove adsorbed gas. Charcoal is used to adsorb gas and remove impurities from a liquid.

Feldspar rock is a hypabyssal rock which is mainly constituted of feldspar and includes orthoclase, as phenocrysts, present in a semicrystalline stone in which amphibole and biotite are mixed. Since it is difficult to determine whether phenocrysts are orthoclase or feldspar, it is called feldspar rock.

Features expected when applying feldspar rock to interior finishes are as follows.

First, feldspar rock is excellent in removing harmful substances and decomposing heavy metals. Feldspar rock is composed of 30,000 to 150,000 multi-layered porous materials per 1 cm³ and has a large specific surface area, it is excellent in adsorbing pollutants and heavy metals and has excellent decomposition effect, cement neutralization effect, antibacterial effect, insect repellent effect and deodorization effect. Recently, feldspar rock is used for dioxin removal.

Second, about 40 kinds of minerals revitalizing the human body are released from feldspar rock, which is effective for metabolism and skin health.

Third, feldspar rock regulates acidic or strongly alkaline water to become weak alkaline (pH 7.2 to 7.4) and activates water to purify water.

Fourth, feldspar rock has abundant dissolved oxygen (O2) and oxygenates. Feldspar rock lowers chemical oxygen demand (COD) and biological oxygen demand (BOD) and increases the amount of oxygen to suppress preservative action, which can impart vitality to the human body.

Fifth, feldspar rock has far-infrared radiation effects such as maintaining the freshness of foods, increasing taste, and promoting blood circulation and metabolism through resonance and absorption.

Diatomite is a collection of deposits made of hard shells called diatoms. In diatomite, silicic acid, a typical chemical component of the earth, accounts for about 90% of chemicals thereof.

Diatomite has a very low density due to mixing of complex structures of diatom shells with other sediments, thereby having characteristics of adsorption, transport, filtration and polishing.

The properties of diatomite are determined according to the type of diatom cells, developmental state, conservation state, impurity content, chemical composition and stability.

The use of diatomite is classified according to physical and chemical uses thereof. Diatomite is formed of a myriad of porous materials, and each particle has a very irregular shape. Accordingly, when it is used to form a filter cake, the filter cake exhibits a porosity of 80 to 95% and many capillary shapes are generated by unique diatomite particles.

In addition, diatomite may be used as a filter.

Diatom fossils are used as filters, which is generally called diatomite filtration. This diatomite is laminated and coated to a thickness of about 2 to 5 mm on a surface of a porous support material or a filtration cartridge. The filter material is used to pressurize water in a pressure vessel to pass through the filter material or to make water to be adsorbed into and pass through the filter material under vacuum.

In addition, diatomite may be used as an abradant.

Diatomite is a precise cutting abradant available for all metals and can polish metals without scratches. In addition, diatomite is used for car polish, tile cleaning and toothpaste.

In addition, diatomite may be used as an absorbent. Diatomite has internal voids like zeolite, thereby being capable of absorbing 2 to 3 times the weight thereof in liquid. Diatomite basically has excellent absorbency of solidifying a liquid and can prevent the absorbed material from leaking again.

Diatomite has a low thermal conductivity. In addition, diatomite does not shrink easily even when fired at high temperature, thereby having strong durability against thermal shock. Accordingly, diatomite can be used as a very hard fireproof material. Diatomite refractory bricks have excellent heat insulation and sound insulation effects and can withstand up to about 1000° C.

In addition, diatomite may be used as an additive.

Diatomite has a very low density, high absorbency, and high chemical stability, thereby being capable of being used as an additive in various fields. Diatomite is mainly used as an additive in the paint industry, the plastics and polyethylene industry, etc. In addition, diatomite is used to suppress glossiness, and the microstructures thereof can aid adhesion.

Diatomite is a sedimentary rock formed by fossilization of only silicic acid parts of diatoms, a kind of phytoplankton, accumulated in the sea or under lakes. Diatomite can purify indoor air. Diatomite has excellent ability of adsorbing and decomposing harmful substances.

For this reason, diatomite, which is a fossil of phytoplankton, contains about 5,000 times more pores than activated charcoal (charcoal). Since the micropores filter out contaminated particles, diatomite is called a superporous body. Micropores of diatomite can maintain humidity. In addition, diatomite has the property of removing odor and smell. In addition, diatomite has a large surface area, a low density, excellent thermal insulation, and fire resistance.

Cypress is a large tree of the cypress family and grows up to 30 to 40 meters in height. Cypress has antibacterial and bactericidal effects like an antibiotic and helps to relieve stress, stabilize mind and body, improve immunity, promote blood circulation, and improve skin diseases. In addition, cypress has good timber quality and good fragrance, and a phytoncide emission amount thereof is the highest among conifers and is 5 times higher than that of juniper, pine and cypress.

In addition, a coating layer may further include a useful microbiome.

The microbiome may include at least one of Lactobacillus delbrueckii, Lactobacillus casei, Lactobacillus bulgaricus, Lactobacillus plantarum, Lactobacillus rhamnosus and micrococcus.

For reference, the useful microbiome is a culture of 80 kinds of useful microorganisms such as yeast, lactic acid bacteria, yeast bacteria, photosynthetic bacteria and actinomycetes. Useful microorganisms refer to good microorganisms such as yeast and lactic acid bacteria. Useful microorganisms can inhibit the growth of harmful microorganisms.

In addition, the coating layer of the surface layer 100 may further include an herb.

The herb may include at least one of dill, anise, laurel, oregano, tarragon, basil, sage, thyme, peppermint, chervil, cilantro, rosemary, hyssop, borage, lovage, savory, and lemon balm. These herbs are merely provided as examples of the present invention, and various herbs may be included according to the purpose of use of the thermal mat.

An herb is included in the coating layer such that the fragrance thereof is emitted from the heating mat. When the heating mat including an herb is used for medical purposes, bedding, yoga, and various sports, it can stabilize the user's mind and body and improve the effects of treatment, sleep, exercise and the like.

In addition, when the coating layer of the surface layer 100 further includes a UV coating agent, ultraviolet light is blocked so that the color of the surface layer 100 is not changed and, accordingly, the appearance may be maintained for a long time.

The UV coating agent may be prepared by mixing 15 to parts by weight of polyvinyl butyral (PVB), 90 to 95 parts by weight of an acrylic monomer, 0.5 to 1 part by weight of a photoinitiator, and 0.5 to 1 part by weight of one or more additives selected from an antifoaming agent, a pigment, a dispersant, and a UV stabilizer.

The polyvinyl butyral (PVB) may be used to facilitate mixing by liquefying polyvinyl butyral and block adhesion force and UV light.

Here, when PVB is used in an amount of less than 15 parts by weight, an ability of blocking adhesion force and ultraviolet light is decreased. When PVB is used in an amount of greater than 20 parts by weight, curing power may be decreased.

The acrylic monomer has excellent transparency, weather resistance, heat resistance, and adhesiveness. The acrylic monomer may be used to adjust the viscosity of a UV coating agent, adhesion force to a substrate, and hardness of the UV coating agent after curing.

Here, when the acrylic monomer is used in an amount of less than 90 parts by weight, adhesiveness may be decreased. When the acrylic monomer is used in an amount of greater than 95 parts by weight, adhesive strength may be decreased.

The photoinitiator, which is a material that absorbs energy from light and initiates polymerization, may be used to speed curing.

Here, when the photoinitiator is used in an amount of less than 0.5 parts by weight, a reaction does not occur. When the photoinitiator is used in an amount of greater than 1 part by weight, curing power increases so that cracks may occur after curing of the UV coating agent.

An antifoaming agent, a pigment, a dispersant, and a UV stabilizer may be used when mixing a composition of the UV coating agent or to facilitate use of the UV coating agent.

When the antifoaming agent and other additives are used in an amount of less than 0.5 parts by weight, the effect is insufficient. When the antifoaming agent and other additives are used in an amount of greater than 1 part by weight, a composition is not mixed well.

The pigment may express the color of the UV coating agent, the dispersant may prevent aggregation of the UV coating agent, and the UV stabilizer may increase the color change prevention effect of the UV coating agent.

The carbon heater 200 may be provided under the surface layer 100 and may emit far infrared rays and generate heat.

The carbon heater 200 may be connected to an electrical device to generate heat and may serve a heating function.

In addition, the carbon heater 200 may emit far infrared rays to perform antibacterial activity and supply far infrared rays to a user to provide far infrared effects.

As such, when heating with the carbon heater 200, heating costs may be reduced due to high energy efficiency, and the risk of fire may be decreased.

In addition, the carbon heater 200 may be formed in a film or fiber shape.

The film-shaped carbon heater is manufactured by attaching a carbon component on a vinyl sheet, such as a film, in a printing manner and has a far infrared ray emission effect. In addition, the film-shaped carbon heater is ready to use like a panel and has a simple structure. In addition, the film-shaped carbon heater may provide partial heating and may be warmed up within 10 minutes.

The fiber-shaped carbon heater is manufactured by weaving fiber coated with carbon or coating fiber with carbon. The fiber-shaped carbon heater may be immediately used and warms immediately upon operation. In addition, the fiber-shaped carbon heater has characteristics such as a high air temperature, a low failure rate, and high resistance to humidity and impact.

The short-circuit prevention layer 300 may be provided under the carbon heater 200.

The short-circuit prevention layer 300 may be provided between the carbon heater 200 and the copper plate 400 to prevent short circuit from occurring between the carbon heater 200 and the copper plate 400.

In addition, the short-circuit prevention layer 300 may be a yarn formed of natural fiber.

Here, the natural fiber may be one or more of pineapple leaf fiber, cotton fiber, coconut fiber, bamboo fiber, banana fiber, ramie fiber and manila hemp.

Pineapple leaf fiber is also called pina and has a similar shape to hemp. Pineapple leaf fiber is a light and eco-friendly material. Pineapple leaf fiber is mainly used for bags, clothing and floor mats.

Cotton fiber is hollow and naturally twisted, so that it is easy to release absorbed moisture and has excellent resilience. In addition, cotton fiber has excellent hygroscopicity and warmth. In addition, cotton fiber has a long lifespan.

Coconut fiber is a fiber that forms a hard skin of coconut fruit and is also called coir fiber. Coconut fiber is water resistant and especially less damaged by sea water.

Bamboo fiber refers to vegetable fiber derived from pure natural bamboo pulp. In addition, bamboo fiber offers cooling sensation and is effective for ultraviolet ray blocking, ion generation, bacteriostatic effect, and fatigue recovery.

In addition, bamboo fiber has a multi-lobal section, a large surface area, and a thin and long cavity on a side thereof, thereby being lightweight, being capable of rapidly absorbing and releasing moisture, and being highly breathable.

In addition, bamboo fiber does not wrinkle well and has high thermal conductivity and a nice touch.

Banana fiber is ecofriendly and has a soft texture that can feel like a fiber made of bamboo. Such banana fiber may be suitable for making clothes such as jackets, skirts and pants. In addition, banana fiber may suitable for mats used by people.

Ramie fiber is natural fiber and becomes stronger when wet. In addition, ramie is highly resistant to mold and may be easily synthesized with cotton or wool. In addition, ramie fiber is very durable, thereby being often used for seats.

Manila hemp fiber is obtained from one type of poncho stalk that lives in the tropics. Manila hemp fiber is light because the center thereof is hollow. In addition, manila hemp fiber has excellent seawater resistance.

In addition, the short-circuit prevention layer 300 may be formed of a highly elastic foam.

Since the short-circuit prevention layer 300 is formed of a highly elastic foam, a feeling of cushioning of the heating mat may be further increased while preventing short circuit between the carbon heater 200 and the copper plate 400.

The highly elastic foam may be an outright material. However, the outright material is merely one example of the present invention, and any materials having elasticity are available.

The copper plate 400 may be provided under the short-circuit prevention layer 300 and may uniformly disperse heat. In addition, the copper plate 400 may exhibit electromagnetic wave blocking effect and water vein blocking effect.

The copper plate 400 may be provided under the short-circuit prevention layer 300, may eliminate a temperature difference in a gap between the first cushion layer 500 and the carbon heater 200, and may prevent loss of heat radiating downward, thereby enabling energy saving.

In addition, the copper plate 400 has excellent electromagnetic wave blocking effect and water vein blocking effect, thereby playing a beneficial role to the human body.

In addition, the copper plate 400 may be formed in one rectangular plate shape, but the present invention is not limited thereto.

In addition, the copper plate 400 may be manufactured by connecting a plurality of copper plate materials 410 with an ‘S’-shaped cross section.

Each of the copper plate materials 410 may have an ‘S’-shaped cross section, and both ends thereof may include coupling portions 411 which are point symmetrical with respect to the both ends.

Each of the coupling portions 411 may be formed in a rolled shape with a curvature so that the copper plate materials 410 are connected to each other.

The plurality of copper plate materials 410 are connected to form the copper plate 400, so that the plurality of coupling portions 411 are formed. Accordingly, water vein blocking effect may be increased.

In addition, the effect obtained by stacking a plurality of copper plates may be obtained even using one copper plate layer. That is, water vein blocking effect may be maximized even using a minimum amount and volume of copper plate, instead of stacking a plurality of rectangular plate-shaped copper plates.

The copper plate 400 may be completely attached to the first cushion layer 500 using an ecofriendly adhesive.

The first cushion layer 500 may be provided under the copper plate 400, thereby providing cushioning.

The first cushion layer 500 may be made of any one of latex, coconut palm, marble foam and polyurethane foam. However, these materials are merely examples of the present invention and may be formed of various materials having a cushioning effect.

Latex is made of natural rubber as a main raw material and has high elasticity. Latex is well ventilated, hygienic, and antibacterial.

Coconut palm is a natural fiber surrounding an inner shell of coconut fruit and is hygienic due to antibacterial properties thereof. Coconut palm has good ventilation, absorbs moisture remaining in the air, and discharges the same when dry, thereby being capable of keeping indoor humidity constant.

Marble foam is a mat manufactured by finely grinding the remainder, remaining after production of various types of sponges, and waste materials, adding a chemical adhesive thereto, and compressing the same. Marble foam is very inexpensive and may be used for a long time due to elasticity thereof.

Polyurethane foam is a special chemically-treated sponge made of polyurethane as a main raw material and has excellent resilience. In addition, polyurethane foam serves to evenly distribute pressure applied to the body along the body flexes and is inexpensive. In addition, polyurethane foam has high thermal insulation, excellent electrical insulation, and high strength.

The bottom layer 600 may be provided under the first cushion layer 500 and may contact the ground.

The bottom layer 600 may protect and cover the first cushion layer 500. In addition, the bottom layer 600 may protect the first cushion layer 500 of the heating mat from the ground.

In addition, the bottom layer 600 may be finished to be connected to the surface layer 100 covering a portion of the bottom of the heating mat.

The bottom layer 600 is applied to be connected to the surface layer 100, and a connection part between the surface layer 100 and the bottom layer 600 is finished using an adhesive, followed by being finally finished using silicone.

The bottom layer 600 may be formed of the same material as the surface layer 100 and may include anti-slip protrusions to prevent slipping of the heating mat.

Here, as the adhesive, an ecofriendly polyvinyl-based adhesive or isocyanate-based adhesive which is free from VOC problems may be used.

In addition, the adhesive may be a natural adhesive and may be prepared by mixing 3 to 8 parts by weight of cationic starch, 3 to 8 parts by weight of dextrin, 3 to 8 parts by weight of soy protein, 3 to 8 parts by weight of milk casein, 3 to 8 parts by weight of aqueous ammonia, 3 to 8 parts by weight of gum arabic, and 3 to 8 parts by weight of sodium alginate based on 100 parts by weight of water.

In addition, as the adhesive, a non-toxic and ecofriendly synthetic resin emulsion adhesive may be used. As the non-toxic and ecofriendly synthetic resin emulsion adhesive, a vinyl acetate-based aqueous adhesive composed of to 55 parts by weight of a vinyl-acetate/ethylene co-polymer emulsion and 35 to 40 parts by weight of water, as a diluent, may be used.

The composition is intended to prevent moisture or water from entering the heating mat. Accordingly, since moisture or water are not absorbed into the heating mat, bacteria and other molds may be prevented from growing in the heating mat.

In addition, since the heating mat is manufactured in an integrated form, the heating mat is durable and may be used for a long time without deformation.

In addition, the heating mat according to the first embodiment of the present invention may further include a durable pad 700 and a second cushion layer 800.

The durable pad 700 may be provided between the surface layer 100 and the carbon heater 200, thereby further reinforcing durability of the heating mat.

The durable pad 700 may be formed of synthetic rubber having high durability and flexibility, such as styrene butadiene rubber (SBR), nitrile-butadiene rubber (NBR), or silicone rubber, or a thermoplastic resin plastic such as polystyrene (PS), polypropylene (PP), polyethylene (PE), or polyethylene terephthalate (PET). However, the present invention is not limited to the materials and the durable pad 700 may be formed of any material having high durability and flexibility.

Accordingly, the durable pad 700 of the heating mat is exposed when a surface of the surface layer 100 is damaged by a user or an external impact, so that the inside of the heating mat may be secondarily protected.

The second cushion layer 800 may be provided between the surface layer 100 and the carbon heater 200, thereby further reinforcing cushioning of the heating mat.

In addition, when the second cushion layer 800 is provided with the durable pad 700, the second cushion layer 800 may be provided between the durable pad 700 and the carbon heater 200.

In addition, the second cushion layer 800 has a feeling of cushioning and may be formed of a material having high thermal conductivity to transfer heat from the carbon heater 200 to a user.

In addition, the second cushion layer 800 may be made of any one of latex, coconut palm, marble foam, and polyurethane foam. However, the materials are merely provided as examples of the present invention, and the second cushion layer 800 may be made of any material having a feeling of cushioning and high thermal conductivity.

The surface layer 100 of the heating mat according to the embodiment of the present invention is made of ecofriendly PVC and is waterproof, so that it is easy to clean foreign substances and the growth of bacteria can be blocked.

In addition, since the heating mat is manufactured in an integrated form, it has high durability. Further, since the heating mat has far infrared ray blocking effect and water vein blocking effect, it may be used not only for medical use but also for bedding, yoga, and various sports.

FIG. 5 is a front sectional view illustrating each layer of a heating mat according to a second embodiment of the present invention.

Referring to FIG. 5, the heating mat according to the second embodiment of the present invention may include a surface layer 100, a carbon heater 200, a first cushion layer 500, a bottom layer 600, a durable pad 700, and a second cushion layer 800. Here, the configuration of the heating mat according to the second embodiment is substantially the same as that of the heating mat according to the first embodiment, except for the short-circuit prevention layer 300 and the copper plate 400 of the heating mat according to the first embodiment. Accordingly, a detailed description is omitted.

The heating mat including the components may be easily used for bedding, medical purposes, etc. and may be used in various fields.

FIG. 6 is a front sectional view illustrating each layer of a heating mat according to a third embodiment of the present invention.

Referring to FIG. 6, the heating mat according to the third embodiment of the present invention may include a surface layer 100, a first cushion layer 500, a bottom layer 600, and a durable pad 700. Here, the configuration of the heating mat according to the third embodiment is substantially the same as that of the heating mat according to the first embodiment, except for the carbon heater 200, short-circuit prevention layer 300, copper plate 400, and second cushion layer 800 of the heating mat according to the first embodiment.

The heating mat including the components may be easily used as a mat for sports such as yoga and indoor exercise and may be used in various fields.

It will be apparent to those skilled in the art that the present invention described above is not limited to the above-described embodiments and various substitutions, modifications, and changes can be made without departing from the technical spirit of the present invention.

1. A heating mat, comprising:
a surface layer formed of one of PVC, PU and TPU;
a carbon heater provided under the surface layer and configured to emit far infrared rays and generate heat;
a short-circuit prevention layer provided under the carbon heater;
a copper plate provided under the short-circuit prevention layer and configured to uniformly disperse heat;
a first cushion layer provided under the copper plate and configured to provide a feeling of cushion; and
a bottom layer provided under the first cushion layer and configured to be in contact with the ground.

2. The heating mat according to claim 1, wherein the short-circuit prevention layer is a yarn formed of natural fiber and the natural fiber is one or more of pineapple leaf fiber, cotton fiber, coconut fiber, bamboo fiber, banana fiber, ramie fiber and manila hemp.

3. The heating mat according to claim 1, wherein the short-circuit prevention layer is formed of a highly elastic foam.

4. The heating mat according to claim 1, wherein the copper plate is formed by connecting a plurality of copper plate materials with an ‘S’-shaped cross section.

5. A heating mat, comprising:
a surface layer formed of one of PVC, PU and TPU;
a carbon heater provided under the surface layer and configured to emit far infrared rays and generate heat;
a first cushion layer provided under the carbon heater and configured to provide a feeling of cushion; and
a bottom layer provided under the first cushion layer and configured to be in contact with the ground.

6. The heating mat according to claim 1, wherein the surface layer is formed to surround from an upper surface of the heating mat to a portion of a lower surface of the heating mat, and the bottom layer is finished using an adhesive to be connected to the surface layer on the lower surface of the heating mat, and then finished using silicone.

7. The heating mat according to claim 1, wherein a coating layer is further provided on the surface layer, wherein the coating layer comprises one or more liquids and nanoparticle powders derived from silver compounds, germanium, bentonite, bamboo charcoal, jade, charcoal, feldspar rock, diatomite, and cypress.

8. The heating mat according to claim 7, wherein the coating layer further comprises a herb, wherein the herb comprises at least one of dill, anise, laurel, oregano, tarragon, basil, sage, thyme, peppermint, chervil, cilantro, rosemary, hyssop, borage, lovage, savory, and lemon balm.

9. The heating mat according to claim 7, wherein the coating layer further comprises a UV coating agent, wherein the UV coating agent is prepared by mixing 15 to 20 parts by weight of polyvinyl butyral (PVB), 90 to 95 parts by weight of an acrylic monomer, 0.5 to 1 part by weight of a photoinitiator, and 0.5 to 1 part by weight of one or more additives selected from an antifoaming agent, a pigment, a dispersant, and a UV stabilizer.

10. The heating mat according to claim 1, wherein a durable pad is further provided between the surface layer and the carbon heater.

11. The heating mat according to claim 1, wherein a second cushion layer is further provided between the surface layer and the carbon heater.

12. A heating mat, comprising:
a surface layer formed of one of PVC, PU and TPU;
a durable pad provided under the surface layer;
a first cushion layer provided under the durable pad and configured to provide a feeling of cushion; and
a bottom layer provided under the first cushion layer and configured to be in contact with the ground.

13. The heating mat according to claim 1, wherein the surface layer is formed to surround from an upper surface of the heating mat to a portion of a lower surface of the heating mat, and the bottom layer is finished using an adhesive to be connected to the surface layer on the lower surface of the heating mat, and then finished using silicone.

14. The heating mat according to claim 1, wherein a coating layer is further provided on the surface layer, wherein the coating layer comprises one or more liquids and nanoparticle powders derived from silver compounds, germanium, bentonite, bamboo charcoal, jade, charcoal, feldspar rock, diatomite, and cypress.

15. The heating mat according to claim 14, wherein the coating layer further comprises a herb, wherein the herb comprises at least one of dill, anise, laurel, oregano, tarragon, basil, sage, thyme, peppermint, chervil, cilantro, rosemary, hyssop, borage, lovage, savory, and lemon balm.

16. The heating mat according to claim 14, wherein the coating layer further comprises a UV coating agent, wherein the UV coating agent is prepared by mixing 15 to 20 parts by weight of polyvinyl butyral (PVB), 90 to 95 parts by weight of an acrylic monomer, 0.5 to 1 part by weight of a photoinitiator, and 0.5 to 1 part by weight of one or more additives selected from an antifoaming agent, a pigment, a dispersant, and a UV stabilizer.

17. The heating mat according to claim 1, wherein a durable pad is further provided between the surface layer and the carbon heater.

18. The heating mat according to claim 1, wherein a second cushion layer is further provided between the surface layer and the carbon heater.
